(19) United States
(12) Patent Application Publication
(10) Pub. No.: US 2007/0160269 A1
(43) Pub. Date: Jul. 12, 2007

(54) Electrical Switch Device with Feature Identification and Method

(76) Inventor: Peng-Chia Kuo, Taipei (TW)

Correspondence Address: LAW OFFICES OF LAI AND ASSOCIATES, P.C., 5800 RANCHESTER STE 200, HOUSTON, TX, 77036, US

(21) Appl. No.: 11/306,621

(22) Filed: Jan. 4, 2006

(51) Int. Cl. G06K 9/00

(52) U.S. Cl. 382/124; 340/5.53; 713/186

(57) ABSTRACT

An electrical switch device with feature identification and a method are applied for an electronic apparatus having a first power supply module. The electrical switch device comprises a switch, a feature identification module and a second power supply module. The second power supply module supplies power to the feature identification module. The switch generates a switch control signal based on an outside signal. The feature identification module is used to receive a feature signal and implements an identification action, then determines whether the first power supply module is activated based on the switch control signal and the identification result.

### FIELD OF THE INVENTION

The present invention relates to an electrical switch apparatus with feature identification and a method and, more particularly, using a fingerprint identification result to determine whether the electronic switch device of an electronic apparatus is activated.

### BACKGROUND OF THE INVENTION

Currently, mobile phones, personal digital assistants (PDA), global positioning systems (GPS), laptops, translators and remote controllers have become important electronic apparatuses in our daily life. A user may take personal data to store in these electronic apparatuses while using these electronic apparatuses. In order to avoid theft, the user often sets numerical or script passwords to prevent others to turn on and use these electronic apparatuses directly. However, these passwords must rely on the user's memory that may be unreliable. If the user forgets these passwords, that causes more inconveniences.

In addition, the cryptosystem starts to operate after the power of the electronic apparatus is turned on. The risk of cracking the system increases once the electronic apparatus is turned on.

To overcome the foregoing shortcomings of the prior arts, the inventor of the present invention based on years of experience on related research and development of the feature identification systems and the electrical switch devices invents an electrical switch device with feature identification and method thereof.

### SUMMARY OF THE INVENTION

Accordingly, the object of the present invention is to provide an electrical switch device with feature identification and a method to improve the security and the convenience for confidential data.

In accordance with the present invention the electrical switch device with feature identification comprises a switch, a feature identification module and a power supply module. A switch control signal is generated by the switch based on an outside signal. A feature signal and the switch control signal are received by the feature identification module and an identification action is then implemented by the feature identification module to generate a control signal. Power is supplied by the power supply module to the feature identification module.

In addition, the present invention further provides an electrical switch device with feature identification that is applied to an electronic apparatus having a first power supply module. The first power supply module is used to supply a power to the electronic apparatus. The electrical switch device comprises a switch, a feature identification module and a second power supply module. A switch control signal is generated by the switch based on an outside signal. A feature signal and the switch control signal are received by the feature identification module and an identification action is then implemented by the feature identification module to determine whether the first power supply module is activated. Power is supplied by the second power supply module to the feature identification module.

Furthermore, the present invention is to provide a method for an electrical switching with feature identification. The method comprises the following steps: providing a second power supply module to supply a power to a feature identification module; providing a switch to receive an outside signal and to generate a switch control signal; employing the feature identification module to receive a feature signal and the switch control signal and to implement an identification action to determine whether the first power supply module is activated.

Other features and advantages of the present invention and variations thereof will become apparent from the following description, drawings, and claims.

### BRIEF DESCRIPTION OF THE DRAWINGS

FIG. 1 is a block diagram illustrating an electrical switch device with feature identification according to an embodiment of the present invention;

FIG. 2 is a block diagram illustrating an electrical switch device with feature identification according to a preferred embodiment of the present invention;

FIG. 3 is a schematic diagram illustrating an electrical switch device with feature identification according to a preferred embodiment of the present invention;

FIG. 4 is a flowchart illustrating a method for an electrical switching with feature identification according to an embodiment of the present invention; and

FIG. 5 is a flowchart illustrating a method for an electrical switching with feature identification according to a preferred embodiment of the present invention.

### DETAILED DESCRIPTION OF THE PREFERRED EMBODIMENTS

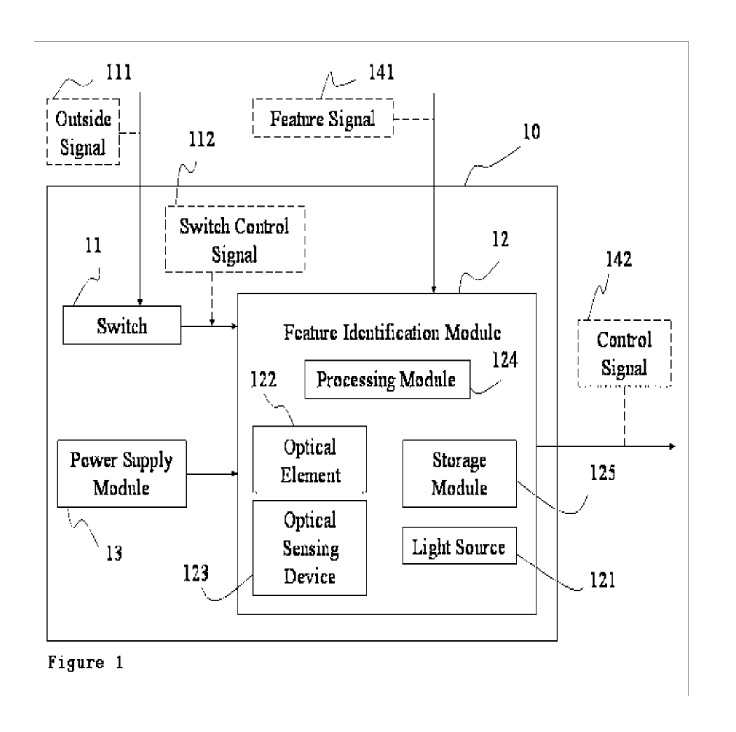

Referring to FIG. 1, a block diagram illustrates an electrical switch device with feature identification according to an embodiment of the present invention. The electrical switch device 10 comprises a switch 11, a feature identification module 12 and a power supply module 13. A switch control signal 112 is generated by the switch 11 based on an outside signal 111. A feature signal 141 and the switch control signal 112 are received by the feature identification module 12 and an identification action is implemented to generate a control signal 142. A power is supplied by the power supply module 13 to the feature identification module 12. The feature identification module 12 comprises a light source 121, an optical element 122, an optical sensing device 123, a processing module 124 and a storage module 125. The feature signal 141 is detected by the light source 121, the optical element 122 and the optical sensing device 123. Secondly, a determination action is implemented by the processing module 124 based on the feature signal 141 and a feature comparison data stored in the storage module 125 and the control signal 142 is then generated based on a determination result.

The switch 11 is a keying, a mechanical switch or an optical sensing switch. The power supply module 13 is a battery. The feature identification module 12 is a fingerprint identification module. The feature signal 141 is a fingerprint image. The identification action is a fingerprint identification action. The light source 121 is a light emitting diode (LED). The optical element 122 is a prism. The optical sensing device 123 is a complementary metal oxide semiconductor (CMOS) image sensor or a charge coupled device (CCD). The processing module 124 is a microprocessor or a microcontroller. The storage module 124 is a flash memory.

The fingerprint identification action is that a fingerprint identification program and a fingerprint identification data are read by the processing module 124 from the storage module 125 first. The fingerprint identification program is then executed to calculate the fingerprint image and the fingerprint identification data in order to determine whether the fingerprint image passes or fails. The fingerprint identification data comprises a predetermined fingerprint image and an identification parameter.

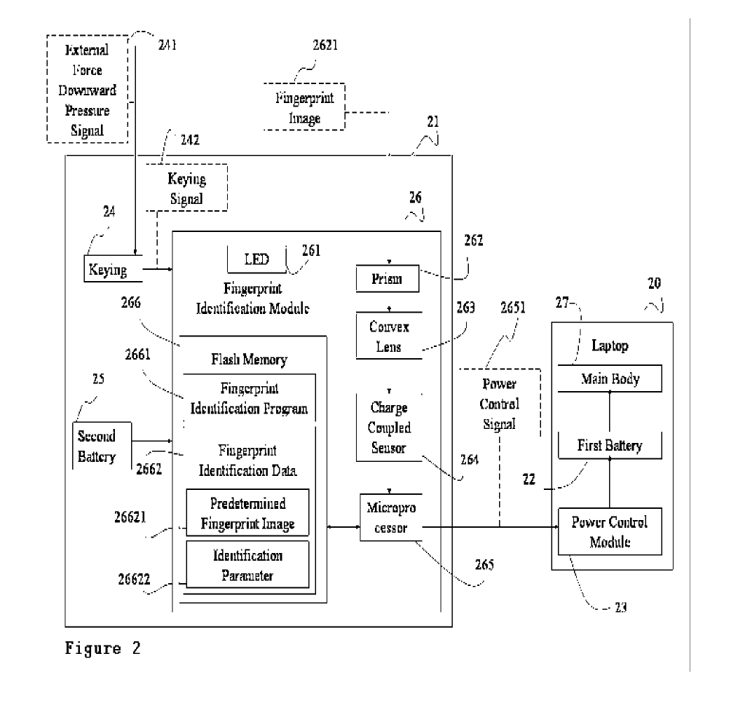

Referring to FIG. 2, a block diagram illustrates an electrical switch device with feature identification according to a preferred embodiment of the present invention. The electrical switch device is applied for a laptop. The laptop 20 comprises a first battery 22, a power control module 23 and a main body 27. The electrical switch device 21 comprises a keying 24, a second battery 25 and a fingerprint identification module 26. The main body 27 provides main functions to the laptop 20. A power is supplied by the first battery 22 to the main body 27. The first battery 22 is controlled by the power supply module 23. The keying 24 is pressed by a user to generate a keying signal 242. A power is supplied by the second battery 25 to the fingerprint identification module 26. The keying signal 242 and a fingerprint image 2621 are received by the fingerprint identification module 26 and a fingerprint identification action is implemented to generate a power control signal 2651. The power control signal 2651 is then transmitted to the power control module 23 to determine whether the power provided by the first battery 23 should be supplied to the main body 27.

The fingerprint identification module 26 comprises a light emitting diode (LED) 261, a prism 262, a convex lens 263, a charge coupled sensor 264, a microprocessor 265 and a flash memory 266. The fingerprint image 2621 is received by the LED 261, the prism 262, the convex lens 263 and the charge coupled sensor 264 and is then transmitted to the microprocessor 265. A fingerprint identification program 2661 and a fingerprint identification data 2662 are read by the microprocessor 265 from the flash memory 266. The fingerprint identification program 2661 is then executed to determine whether the fingerprint image 2621 matches a predetermined fingerprint image 26621 based on the predetermined fingerprint image 26621 of the fingerprint identification data 2662 and an identification parameter 26622. If the fingerprint image 2621 matches the predetermined fingerprint image 26621, a power control signal 2651 is sent by the microprocessor 265 to turn on the power. The first battery 22 is controlled by the power control module 23 to supply the power to the main body 27 for implementing a turn on procedure when the power control signal 2651 is received by the power control module 23. In addition, the fingerprint identification module 26 can be controlled by the keying signal 242 sent from the keying 24 based on demands. The keying signal 242 is transmitted to activate the fingerprint identification module 26 to implement fingerprint identification when an external force downward pressure signal 241 is sensed by the keying 24.

The electrical switch device 21 is applied for a personal digital assistant (PDA), a global positioning system (GPS), a translator, a portable communication apparatus or a remote controller as well. The user can set and store the predetermined fingerprint image 26621. The exclusive right for the electronic apparatus owned by the user can be ensured and a better protection performance can be provided for the data stored in the electronic apparatus to reduce losses when the electronic apparatus is lost.

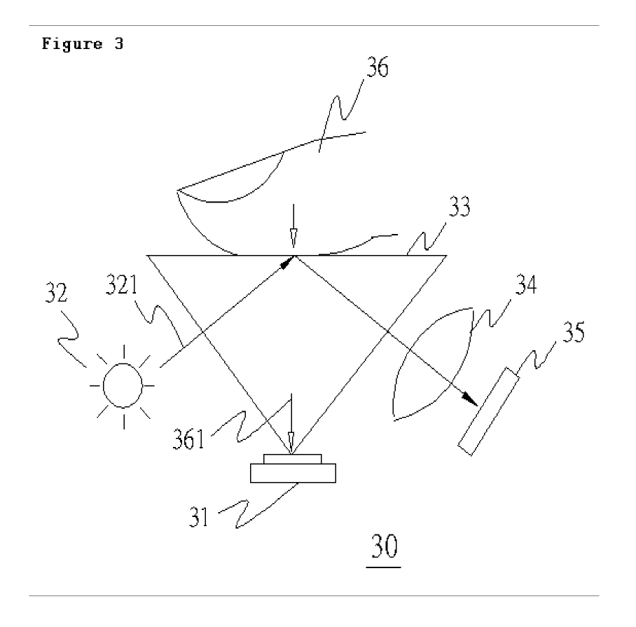

Referring to FIG. 3, a schematic diagram illustrates an electrical switch device with feature identification according to a preferred embodiment of the present invention. The electrical switch device 30 comprises a keying 31, a light emitting diode (LED) 32, a prism 33, a convex lens 34, a charge coupled sensor 35, a microprocessor (not shown) and a flash memory (not shown). The prism 33 is set upon the keying 33. An external force downward pressure signal 361 is transmitted to the keying 31 through the prism 33 and a keying signal is generated to activate the LED 32, the charge coupled sensor 35, the microprocessor (not shown) and the flash memory (not shown) when a finger 35 of the user presses the prism 33. An incident light 321 is emitted by the LED 32. The incident light 321 is reflected to the convex lens 34 via the prism 33 and is concentrated to the charge coupled sensor 35 through the convex lens 34. The fingerprint image of the finger 36 can be sensed by the charge coupled sensor 35 and the microprocessor (not shown) then determines whether the fingerprint image belongs to an allowed user.

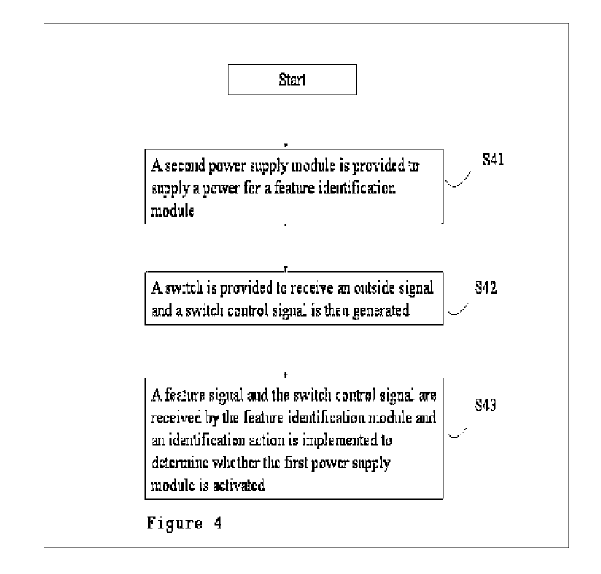

Referring to FIG. 4, a flowchart illustrates a method for an electrical switching with feature identification according to an embodiment of the present invention. The method is applied for an electronic apparatus. The electronic apparatus has a first power supply module for supplying a power to the electronic apparatus. The method comprises the following steps: Step S41, a second power supply module is provided to supply a power for a feature identification module. Secondly, step S42, a switch is provided to receive an outside signal and a switch control signal is then generated. Lastly, step S43, a feature signal and the switch control signal are received by the feature identification module and an identification action is implemented to determine whether the first power supply module is activated. The switch is a keying, a mechanical switch or an optical sensing switch. The first power supply module is a battery or a socket power. The second power supply module is a battery or a socket power. The feature identification module is a fingerprint identification module. The feature signal is a fingerprint image. The identification action is a fingerprint identification action and is accomplished by software.

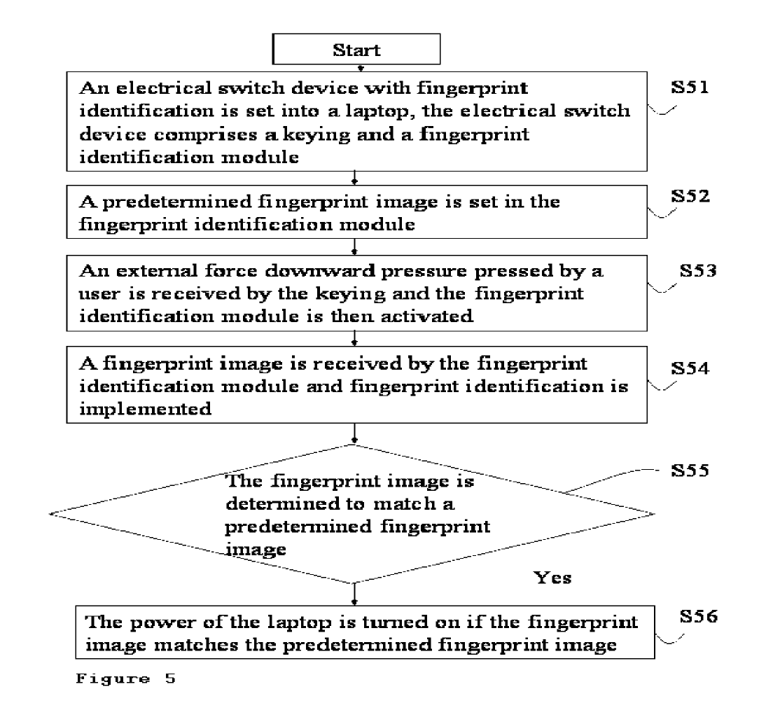

Referring to FIG. 5, a flowchart illustrates a method for an electrical switching with feature identification according to a preferred embodiment of the present invention. The method comprises the following steps: Step S51, an electrical switch device with fingerprint identification is set into a laptop, the electrical switch device comprises a keying and a fingerprint identification module. Secondly, step S52, a predetermined fingerprint image is set in the fingerprint identification module. Step S53, an external force downward pressure pressed by a user is received by the keying and the fingerprint identification module is then activated. Step S54, a fingerprint image is received by the fingerprint identification module and fingerprint identification is implemented. Step S55, the fingerprint image is determined to match a predetermined fingerprint image. Lastly, step S56, the power of the laptop is turned on if the fingerprint image matches the predetermined fingerprint image.

Although the features and advantages of the embodiments according to the preferred invention are disclosed, it is not limited to the embodiments described above, but encompasses any and all modifications and changes within the spirit and scope of the following claims.

What is claimed is:

1. An electrical switch device with feature identification, comprising:
a switch, a generated switch control signal based on an outside signal;
a feature identification module, receiving said switch control signal and a feature signal and implementing an identification action to generate a control signal; and
a power supply module, provided a power to said feature identification module.

2. The electrical switch device of claim 1, wherein said power supply module is a battery.

3. The electrical switch device of claim 1, wherein said switch is a keying or an optical sensing switch.

4. The electrical switch device of claim 1, wherein said feature identification module comprises a light source, an optical element, an optical sensing device, a processing module and a storage module.

5. The electrical switch device of claim 4, wherein said feature signal is a fingerprint image.

6. The electrical switch device of claim 5, wherein said storage module is for storing a fingerprint identification program and a fingerprint identification data, said fingerprint identification data includes a predetermined fingerprint image and an identification parameter.

7. An electrical switch device with feature identification, applied for an electronic apparatus having a first power supply module for supplying a power to said electronic apparatus, said electrical switch device comprising:
a switch, a generated switch control signal based on an outside signal;
a feature identification module, receiving said switch control signal and a feature signal and implementing an identification action to determine whether said first power supply module is activated; and
a second power supply module, provided a power to said feature identification module.

8. The electrical switch device of claim 7, wherein said electronic apparatus is a laptop, a personal digital assistant (PDA), a global positioning system (GPS), a translator, a portable communication apparatus or a remote controller.

9. The electrical switch device of claim 7, wherein said first power supply module is a battery or a socket power.

10. The electrical switch device of claim 7, wherein said second power supply module is a battery.

11. The electrical switch device of claim 7, wherein said switch is a keying or an optical sensing switch.

12. The electrical switch device of claim 7, wherein said feature identification module comprises a light source, an optical element, an optical sensing device, a processing module and a storage module.

13. The electrical switch device of claim 12, wherein said feature signal is a fingerprint image.

14. The electrical switch device of claim 13, wherein said storage module is for storing a fingerprint identification program and a fingerprint identification data, said fingerprint identification data includes at least a predetermined fingerprint image and an identification parameter.

15. A method for an electrical switching with feature identification, applied to an electronic apparatus having a first power supply module for supplying a power to said electronic apparatus, said method comprising following steps:
providing a second power supply module to supply a power to a feature identification module;
providing a switch to receive an outside signal and to generate a switch control signal; and
employing said feature identification module to receive a feature signal and said switch control signal and to implement an identification action to determine whether said first power supply module had been activated.

16. The method for an electrical switching of claim 1 5, wherein said electronic apparatus is a laptop, a personal digital assistant (PDA), a global positioning system (GPS), a translator, a portable communication apparatus or a remote controller.

17. The method for an electrical switching of claim 1 5, wherein said first power supply module is a battery or a socket power and said second power supply module is a battery.

18. The method for an electrical switching of claim 1 5, wherein said feature identification module comprises a light source, an optical element, an optical sensing device, a processing module and a storage module.

19. The method for an electrical switching of claim 18, wherein said feature signal is a fingerprint image.

20. The method for an electrical switching of claim 19, wherein said storage module is for storing a fingerprint identification program and a fingerprint identification data, said fingerprint identification data includes a predetermined fingerprint image and an identification parameter.
